(19) United States
(12) Patent Application Publication
(10) Pub. No.: US 2015/0298600 A1
(43) Pub. Date: Oct. 22, 2015

(54) Carter Concepts - Police Vehicle Safety Arrows Window (PVSAII)

(71) Applicant: Pamela Alethia Carter, Atlanta, GA (US)

(72) Inventor: Pamela Alethia Carter, Atlanta, GA (US)

(21) Appl. No.: 14/255,976

(22) Filed: Apr. 18, 2014

(51) Int. Cl. B60Q 1/30; B60Q 1/46

(52) U.S. Cl. CPC B60Q 1/302; B60Q 1/46

(57) ABSTRACT

Carter Concepts—Police Vehicle Safety Arrows Window (PVSAII) is an automotive rear glass window with embedded electrically lit, sequentially moving safety arrows. These embedded safety arrows will be used when police vehicles are parked along the roadside. The rear glass window embedded safety lighting device reminds drivers to move over to the left or right, assisting in police officer safety while on the highways.

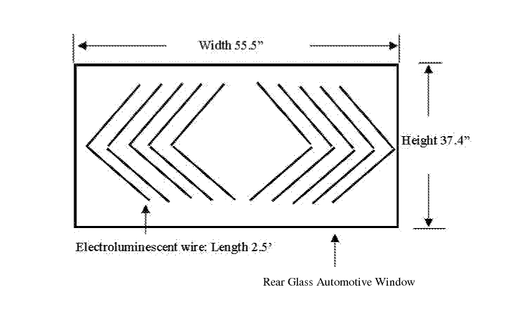

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Carter Concepts—Police Vehicle Safety Arrows Window (PVSAII) is a vehicle rear window with embedded lighting arrows within the glass for vehicle illumination and signaling. This product is equipment for safety, protection and warns with directing-type light. This product will aid against danger and assist with safety.

### BRIEF SUMMARY OF THE INVENTION

Carter Concepts—Police Vehicle Safety Arrows Window (PVSAII) is an electronically activated safety device made of glass with embedded (similar to a rear defroster) lighting arrows. The main usage would be for emergency vehicles, such as a police vehicle. The large electrically lit arrows signal oncoming traffic to move over to the right or to the left of the parked police vehicle on the roadside or highway. The sequential gesturing arrows embedded in the glass window will assist in the safety of the police officer.

### BRIEF DESCRIPTION OF THE SEVERAL VIEWS OF THE DRAWING

A rear automotive vehicle window with embedded illuminating LED lighting arrows. These arrows would have the ability to sequentially move to the left or to the right of the entire window.

### DETAILED DESCRIPTION OF THE INVENTION

Carter Concepts—Police Vehicle Safety Arrows Window (PVSAII) is a safety product signaling other vehicles to move over to the left or to the right of a parked police vehicle. Carter Concepts—Police Vehicle Safety Arrows Window (PVSAII) are illuminating lit arrows that are embedded (similar to a rear defroster) in the glass window. The arrows embedded in the rear glass window will move one at a time in a sequential pattern, to the left or to the right when activated. The arrows embedded in the glass will not obscure visibility. This product will assist in the protection of police officers or emergency personnel handling issues on the roadways by reminding citizens to move their vehicles over with large gesturing lit arrows.

1. Carter Concepts—Police Vehicle Safety Arrows Window (PVSAII) is an automotive rear window with electrical, sequentially patterned, illuminating safety signaling arrows, which have the ability to move to the right or left and are embedded within the rear glass window.
